(19) United States
(12) Patent Application Publication
(10) Pub. No.: US 2013/0124644 A1
(43) Pub. Date: May 16, 2013

(54) REPUTATION SERVICES FOR A SOCIAL MEDIA IDENTITY

(71) Applicants: Simon Hunt, Naples, FL (US); Matthew Brinkley, Portland, OR (US); Anthony Lewis Aragues, JR., Woodstock, GA (US)

(72) Inventors: Simon Hunt, Naples, FL (US); Matthew Brinkley, Portland, OR (US); Anthony Lewis Aragues, JR., Woodstock, GA (US)

(73) Assignee: MCAFEE, INC., Santa Clara, CA (US)

(21) Appl. No.: 13/294,417

(22) Filed: Nov. 11, 2011

(51) Int. Cl. G06F 15/16

(52) U.S. Cl. 709/206

(57) ABSTRACT

Reputation services can determine a “reputation” to associate with a Social Media Identity. For example, a social media identity may develop a trustworthy or an untrustworthy reputation. An untrustworthy reputation can be attained if a user (i.e., identity) posts content similar to email spam messages or links to inappropriate content. Inappropriate content can include illegal copies of material (e.g., violation of copyright) or malicious content among other types. Reputation can be used to inform other users of the potential “quality” of that identity's posts or to filter posts from a particular identity so as not to “bother” other users. An identity's reputation could also be calculated across a plurality of Social Media sites when identifying information from each site can be related to a real world entity. Individual users could set their own filtering options to enhance and refine their own experience on Social Media sites.

### FIELD OF DISCLOSURE

This disclosure relates generally to a system and method for providing a “reputation” for a Social Media identity and for a Reputation Service (RS) available to users of Social Media sites. More particularly, but not by way of limitation, this disclosure relates to systems and methods to determine a reputation of an identity based on a plurality of conditions and, in some embodiments, across a plurality of Social Media and other types of web environments which may not fall strictly under the category of “Social Media.” Users can then use the determined reputation to possibly filter information from an “untrustworthy” identity or highlight information from a “trustworthy” identity.

### BACKGROUND

Today the popularity of Social Media is very high and appears to continue to become more popular. Many different types of “social” interaction can take place via Internet sites. Some types of sites (e.g., Facebook®, LinkedIN® and Twitter®) are primarily concerned with sharing content of a purely social nature. (FACEBOOK is a registered trademark of Facebook, Inc., LINKEDIN is a registered trademark of linkedIN Corp., TWITTER is a registered trademark of Twitter, Inc.) Other types of sites have been used and continue to be used to share a combination of social and business relevant information. For example, professional web logs (blogs) and forum sites allow individuals to collaborate on discussion topics and share information and content directed toward a particular topic for an interested Internet community. A third type of “social” interaction on the web takes place when a buyer and seller make a transaction on sites such as eBay®, Craigslist®, Amazon.com®, etc. And still other types of “social” interaction take place on dating sites (e.g., Match.com®, eHarmony.com®etc.), ancestry cites (Ancestry.com®, MyHeritage.com, etc.), and reunion sites to name a few. (eBay is a registered trademark of eBay Inc., Craigslist is a registered trademark of craigslist, Inc., Amazon.com is a registered trademark of Amazon.com, Inc., match.com is a registered trademark of Match.com, LLC., eharmony.com is a registered trademark of eharmony.com Corp., and Ancestry.com is a registered trademark of Ancestry.com Operations Inc.).

In each of these types of social environments on the web, it may be possible for a user to become an “untrustworthy” participant and perhaps propagate inappropriate, malicious, factually inaccurate, or electronically hazardous materials (e.g., malware) to other interested users. “Inappropriate content” includes, but is not limited to: inaccurate content; malicious content; illegal content; or annoyance content, etc. Even a “trustworthy” participant can sometimes provide content that may be considered “inappropriate content,” however, the percentage of time that this happens should be low. Additionally, there are numerous examples where electronic messages (e.g., tweets, short messages, emails, etc.) purporting to be from celebrities or politicians have been faked resulting in an inappropriate post.

If a social environment becomes overly populated with “untrustworthy” content the popularity of that environment will diminish or die. Prior art solutions to limit bad content are typically directed to areas other than social media such as “email filters” that look for malicious content (e.g., viruses, malware, Trojans, spyware, etc.) or for spam-like content (e.g., advertisements, chain e-mails, etc.) and do not address a solution for social media interaction. Generally, when a user is deemed “untrustworthy” or “trustworthy” that user has formed a “reputation.”

To address these and other problems users encounter with social media content, systems and methods are disclosed to provide a Reputation Service “RS” which can determine a score for individual posts and to determine an aggregate score for identities providing the individual posts. Given this score, other users and user devices can receive an indication of an “untrustworthy” post or an “untrustworthy” user. Actions devices can take based on these types of indications, and other improvements for providing Reputation Services for a Social Media identity are described in the Detailed Description section below.

### BRIEF DESCRIPTION OF THE DRAWINGS

FIG. 1 is a block diagram illustrating network architecture 100 according to one embodiment.

FIG. 2 is a block diagram illustrating a computer on which software according to one embodiment may be installed.

FIG. 3 is a block diagram of a Global Threat Intelligence (GTI) cloud configured to perform a Reputation Service (RS) according to one embodiment.

FIG. 4 is a block diagram of a representation of the Internet, Social Media sites, and users (e.g., identities) to illustrate one embodiment.

FIG. 5A is a flowchart illustrating a process for determining a reputation score for a Social Media identity from a single Social Media environment according to one embodiment.

FIG. 5B is a flowchart illustrating a process for determining a reputation score for a Social Media identity from a plurality of Social Media environments and other web environments according to one embodiment.

### DETAILED DESCRIPTION

Various embodiments, described in more detail below, provide a technique for determining a reputation for a Social Media identity and for providing a Reputation Service (RS) to provide reputation information to subscribers of the service. The implementation could utilize a “cloud” of resources for centralized analysis. Individual users and systems interacting with the cloud need not be concerned with the internal structure of resources in the cloud and can participate in a coordinated manner to ascertain potential “untrustworthy” and “trustworthy” users on the Internet in Social Media sites and other web environments. For simplicity and clearness of disclosure, embodiments are disclosed primarily for a tweet message. However, a user's interaction with other Social Media environments (such as Facebook, LinkedlN, etc.) and web commerce communities (such as eBay, Amazon, etc.) could similarly be measured and provide input to a reputation determination. In each of these illustrative cases, users can be protected from or informed about users who may be untrustworthy. Alternatively, “trustworthy” users can benefit from a good reputation earned over time based on their reliable interaction in their Internet activities.

Also, this detailed description will present information to enable one of ordinary skill in the art of web and computer technology to understand the disclosed methods and systems for determining a reputation and implementing an RS for identities on Social Media and other web communities. As explained above, computer users post many types of items to the Internet. Posts can include links to songs, movies, videos, software, among other things. Other users in turn can initiate a download of posted content in a variety of ways. For example, a user could “click” on a link provided in a message (e.g., tweet or blog entry). Also, content of a post could be deemed inappropriate, as explained above, because the content may be considered spam-like or reference (via link) malicious or illegal downloads. To address these and other cases, systems and methods are described here that could inform the user of a “quality” score for the post based on the post itself and a determined score for the identity making the post.

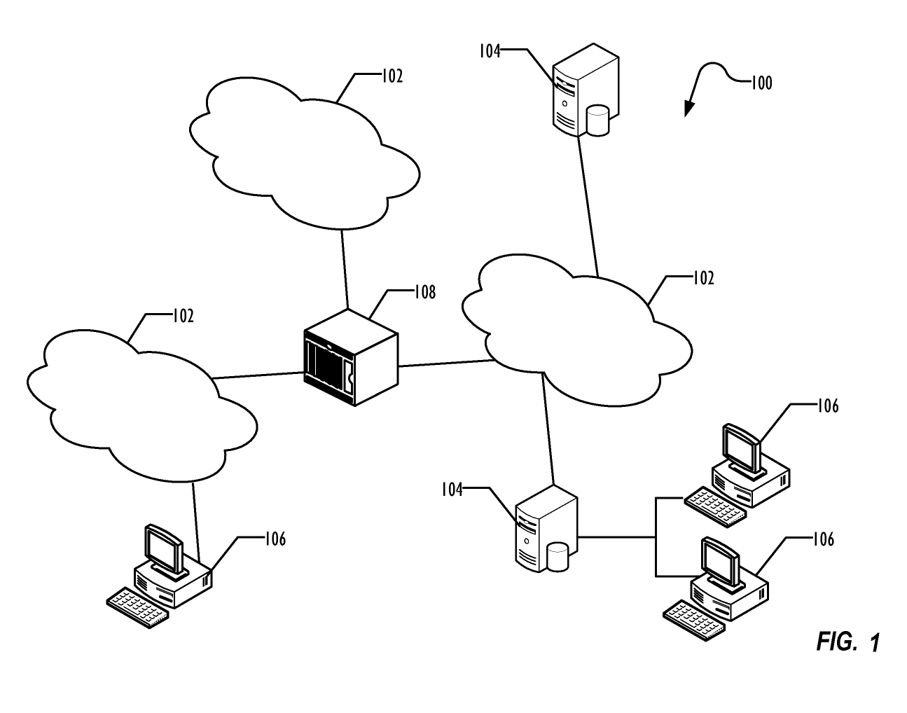

FIG. 1 illustrates network architecture 100 in accordance with one embodiment. As shown, a plurality of networks 102 is provided. In the context of the present network architecture 100, networks 102 may each take any form including, but not limited to, a local area network (LAN), a wireless network, a wide area network (WAN) such as the Internet, etc.

Coupled to networks 102 are data server computers 104 which are capable of communicating over networks 102. Also coupled to networks 102 and data server computers 104 is a plurality of end user computers 106. Such data server computers 104 and/or client computers 106 may each include a desktop computer, lap-top computer, hand-held computer, mobile phone, peripheral (e.g. printer, etc.), any component of a computer, and/or any other type of logic. In order to facilitate communication among networks 102, at least one gateway or router 108 is optionally coupled there between.

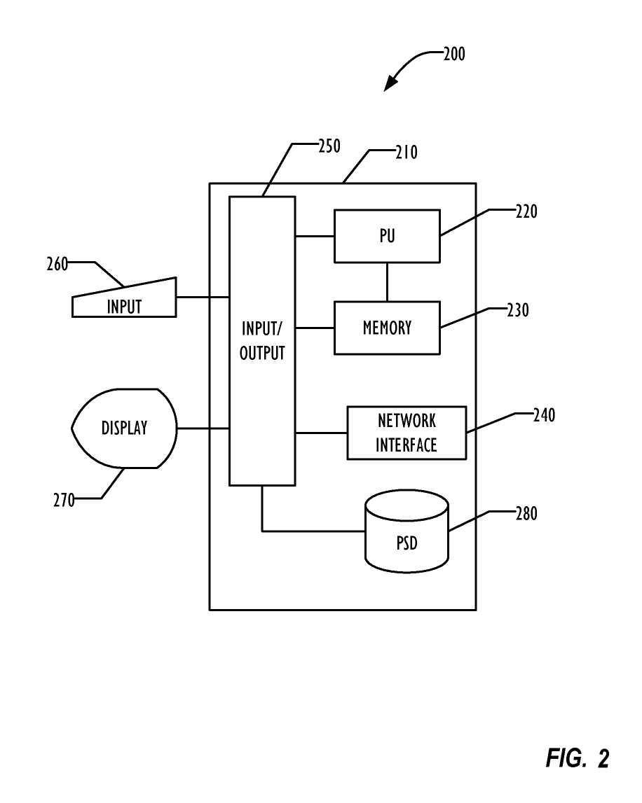

Referring now to FIG. 2, an example processing device 200 for use in providing a reputation and RS according to one embodiment is illustrated in block diagram form. Processing device 200 may serve as a gateway or router 108, client computer 106, or a server computer 104. Example processing device 200 comprises a system unit 210 which may be optionally connected to an input device for system 260 (e.g., keyboard, mouse, touch screen, etc.) and display 270. A program storage device (PSD) 280 (sometimes referred to as a hard disc or computer readable medium) is included with the system unit 210. Also included with system unit 210 is a network interface 240 for communication via a network with other computing and corporate infrastructure devices (not shown). Network interface 240 may be included within system unit 210 or be external to system unit 210. In either case, system unit 210 will be communicatively coupled to network interface 240. Program storage device 280 represents any form of non-volatile storage including, but not limited to, all forms of optical and magnetic memory, including solid-state, storage elements, including removable media, and may be included within system unit 210 or be external to system unit 210. Program storage device 280 may be used for storage of software to control system unit 210, data for use by the processing device 200, or both.

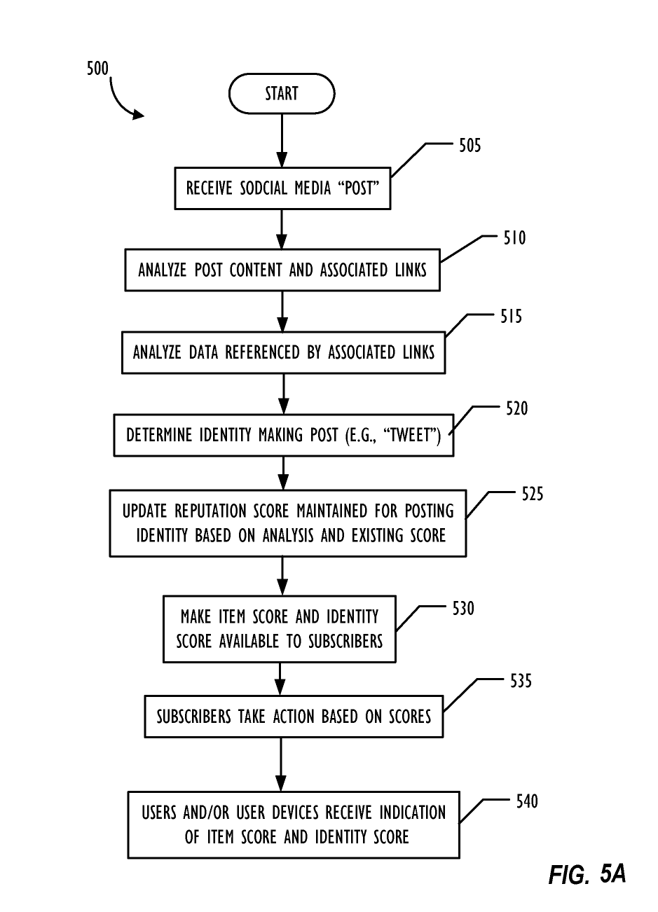

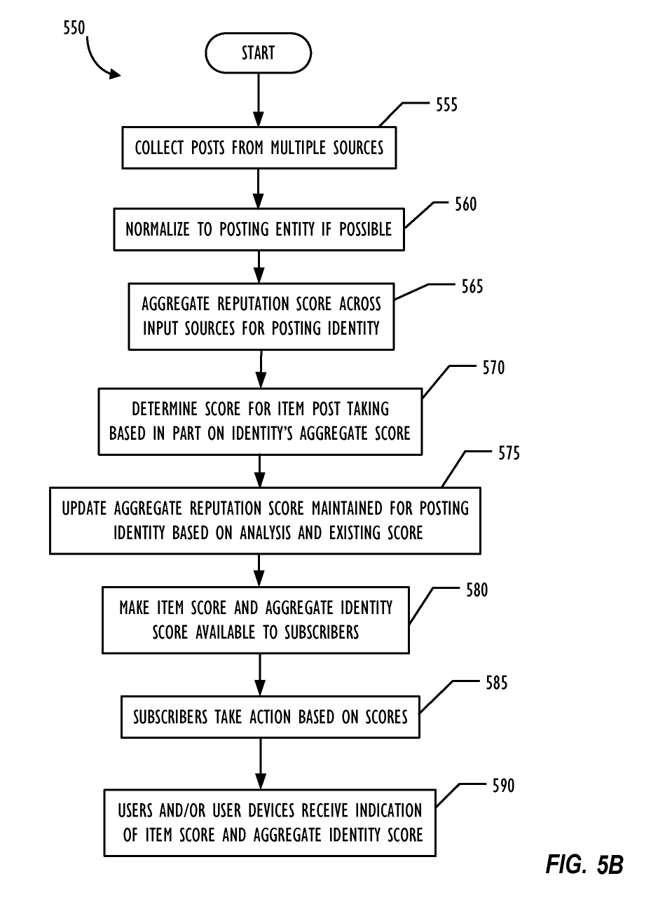

System unit 210 may be programmed to perform methods in accordance with this disclosure (examples of which are in FIGS. 5A-B). System unit 210 comprises a processor unit (PU) 220, input-output (I/O) interface 250 and memory 230. Processing unit 220 may include any programmable controller device including, for example, a mainframe processor, or one or more members of the Intel Atom®, Core®, Pentium and Celeron® processor families from Intel Corporation and the Cortex and ARM processor families from ARM. (INTEL, INTEL ATOM, CORE, PENTIUM, and CELERON are registered trademarks of the Intel Corporation. CORTEX is a registered trademark of the ARM Limited Corporation. ARM is a registered trademark of the ARM Limited Company). Memory 230 may include one or more memory modules and comprise random access memory (RAM), read only memory (ROM), programmable read only memory (PROM), programmable read-write memory, and solid-state memory. PU 220 may also include some internal memory including, for example, cache memory.

Processing device 200 may have resident thereon any desired operating system. Embodiments may be implemented using any desired programming languages, and may be implemented as one or more executable programs, which may link to external libraries of executable routines that may be provided by the provider of the illegal content blocking software, the provider of the operating system, or any other desired provider of suitable library routines. As used herein, the term “a computer system” can refer to a single computer or a plurality of computers working together to perform the function described as being performed on or by a computer system.

In preparation for performing disclosed embodiments on processing device 200, program instructions to configure processing device 200 to perform disclosed embodiments may be provided stored on any type of non-transitory computer-readable media, or may be downloaded from a server 104 onto program storage device 280.

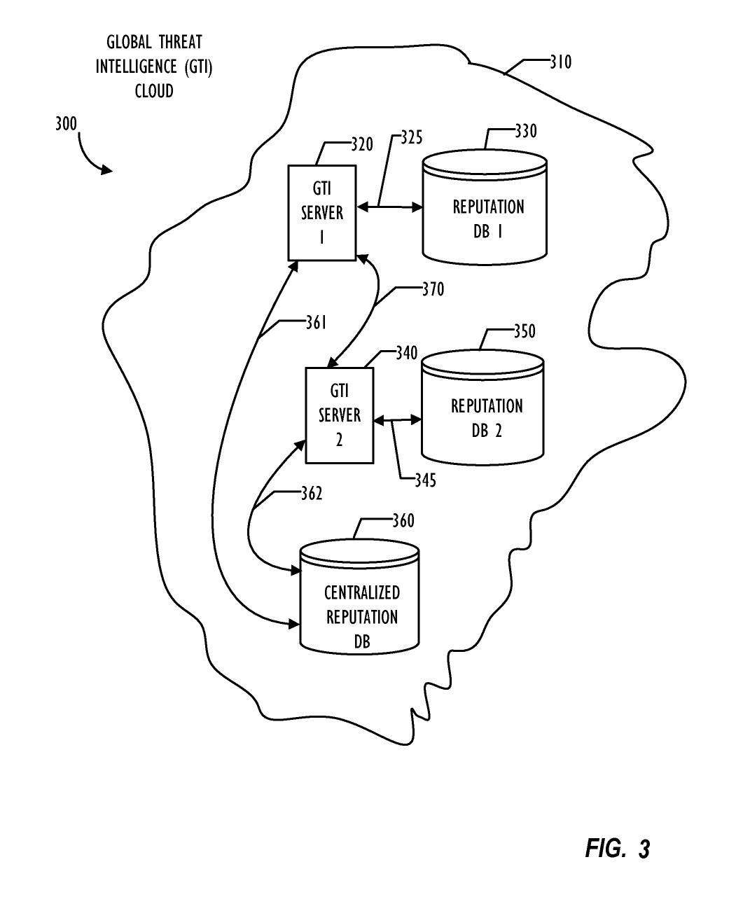

Referring now to FIG. 3, a block diagram 300 illustrates one example of a GTI cloud 310. A GTI cloud 310 can provide a centralized function for a plurality of clients (sometimes called subscribers) without requiring clients of the cloud to understand the complexities of cloud resources or provide support for cloud resources. Internal to GTI cloud 310, there are typically a plurality of servers (e.g., Server 1 320 and Server 2 340). Each of the servers is, in turn, typically connected to a dedicated data store (e.g., 330 and 350) and possibly a centralized data store, such as Centralized Reputation DB 360. Each communication path is typically a network or direct connection as represented by communication paths 361, 362 and 370. Although diagram 300 illustrates two servers and a single centralized reputation database 360, a comparable implementation may take the form of numerous servers with or without individual databases, a hierarchy of databases forming a logical centralized reputation database, or a combination of both. Furthermore, a plurality of communication paths and types of communication paths (e.g., wired network, wireless network, direct cable, switched cable, etc.) could exist between each component in GTI cloud 310. Such variations are known to those of skill in the art and, therefore, are not discussed further here. Also, although disclosed herein as a cloud resource, the essence of functions of GTI cloud 310 could be performed, in an alternate embodiment, by conventionally configured (i.e., not cloud configured) resources internal to an organization.

To facilitate reputation services for social media identities, GTI cloud 310 can include information and algorithms to map a posting entity back to a real world entity. For example, a user's profile could be accessed to determine a user's actual name rather than their login name. The actual name and other identifying information (e.g., residence address, email account, birth date, resume information, etc.) available from a profile could be compared with information gathered from another profile on another site and used to normalize the multiple (potentially different) login identifiers back to a common real world entity. Also, GTI cloud 310 can include information about accounts to assist in determining a reputation score. For example, a twitter account existing for less than 7 days may have an average reputation, the same account posting a GTI flagged bad link may immediately be flagged as dangerous. In contrast, an account existing for some months, with a history of innocent link posting, would not be penalized for an occasional malware link. To define a “score” for the identity items and account information such as age, history, frequency, connections to other social media accounts, connections to a physical person, etc. could be used. This “score” could be used by filtering software such as personal firewalls, web filters etc., to strip content posted by identified low reputation accounts or to provide an indication to other users via a visual indicator (an indication of which could be received or added) when the post is made available to a receiving user. Alternatively or in addition, a pop up style message could appear when a user accesses the questionable post.

User reputation could be calculated using a supervised learning algorithm along with defined business rules. Business rules may determine a reputation level for filtering an organization's accessible content (e.g., content to prevent from passing a corporate firewall) or provide a business-specific algorithm to use in conjunction with other disclosed embodiments. The supervised learning algorithm could be trained to classify user accounts in one of the score dimensions (e.g., malicious link tweeter, spammy tweeter, unreliable information tweeter, etc.). The training set could be labeled using automated systems with some possible human interaction as needed. For example, users who send tweets with links to malware can be automatically labeled by analyzing a tweet's link and content with a suite of security software—e.g., anti-virus, cloud-based URL reputation services (such as GTI cloud 310) etc. The twitter user attributes used in training can include, but may not necessarily be limited to:
Account age—the length of time an account has been active.
Number and reputation of followers—Using a count of the user's followers is easy to calculate but may also be easy to manipulate using the twitter analog of web page “link farms”. In addition to number, a more comprehensive approach could include recursively calculating the reputation scores for all followers and use a weighted average, as is done in the PageRank algorithm.
Citations in “re-tweets”—just as having followers may boost a user's reputation, so too can citations of a user in a re-tweet from a user with a reputable source. As with the previous attribute, this one could also be calculated factoring in the importance/reputation of the re-tweeter using something like the PageRank algorithm.
Validation through external sources: (e.g., through web link for twitter user or Google search for the @user)—Validation for example against a national identity, or a reliable corporate identifier or other (RelyID® which provides online identity verification for example). (RelyID is a registered trademark of RelyID, LLC.).
Message entropy: Bots, spammers and malware propagators often send the same or very similar tweets (ignoring # and @ tags and the URL)—entropy can be calculated over a rolling window and the minimum or mean entropy can be used as a training attribute. Similarity between messages and accounts with low entropy could be given a lower reputation.
One-way conversations: The number of directed tweets that are not replied to—often bots will watch for a certain keyword (e.g., iPad) and then send a private reply to that user with a spammy/malicious link. Presumably the majority of these unsolicited messages will not be replied to, so counting such tweets may be an effective attribute for classification.
Tweet History: Typically, a user's tweet history is comprised of general tweets to the world, and a portion of direct messages to a small collection of named users. However, in the case of malicious spam activity it is common to find minimal worldwide messages and a high portion of direct messages to a large number of named individuals. By following this pattern the spammer hopes to have his messages viewed by a larger population. Therefore, if the ratio of direct messages versus worldwide tweets is higher than a threshold an accounts reputation could be lowered.

Once the machine learning model has been trained, new users (i.e., posts of first impression) can be submitted to the model and classified as trustworthy, potentially spammy, potentially malicious (or gradients between these extremes.) These classifications (i.e., identity's score) can be used in security applications to perform functions including, but not limited to:
Filtering out tweets from users with low reputation scores. User reputation can be made available as a cloud service (such as GTI cloud 310), and twitter apps can integrate with this information feed to organize tweets accordingly. For example, an analog to the email “spam folder” could be used to segregate potentially unwanted or malicious tweets.
Services that perform security analysis of links distributed via Twitter can make use of the reputation information to alter their scanning and analysis logic. For example, certain tests may be time-intensive and infeasible to perform on every tweeted URL, or may have a false-positive rate high enough to preclude use on every tweet. These tests may therefore only be fully applied to tweets from users with a low reputation score.

Other “features” which could be extracted from transactions (e.g., posts, dates, sales) and used as metrics for establishing reputation include graph properties of relationships (friends of friends etc.), direct addressing of the user in Twitter (implies a real-world relationship), text-learning techniques to analyze for spam, profanity etc., network properties of postings (same server/IP, domain age), unfollowings/unfriending type activity, consistency of information between social environments, seller rankings on e-commerce sites, and other rating type information on other available sites to which the identity can be mapped.

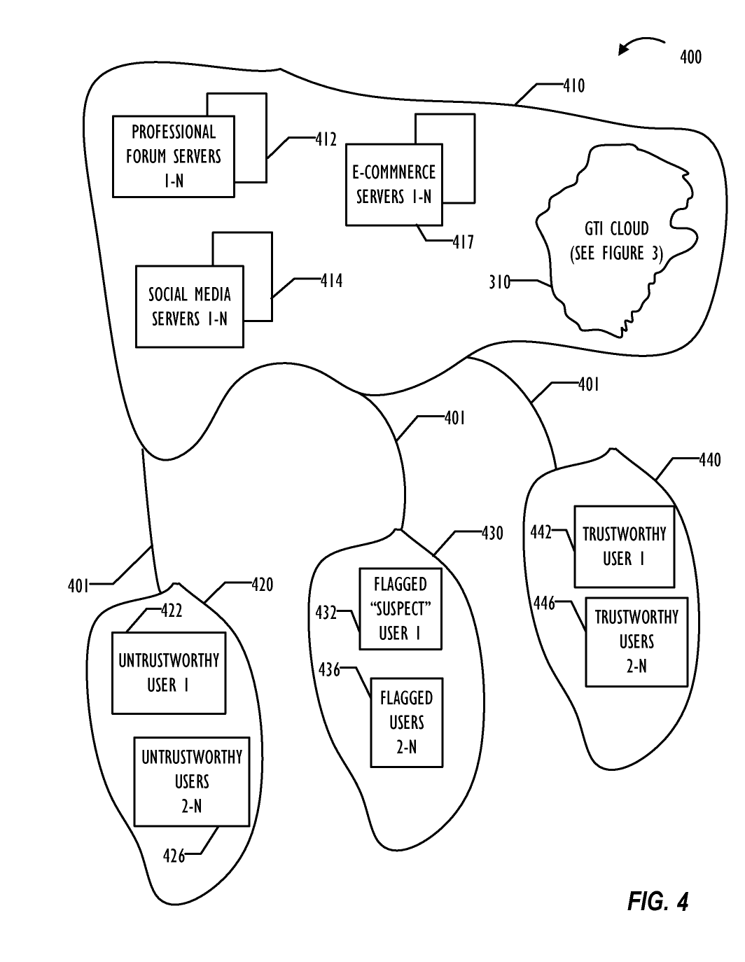

Referring now to FIG. 4, block diagram 400 illustrates a plurality of user types (420, 430 and 440) connected by connection links 401 to Internet 410 and to each other (via Internet 410). User types 420, 430 and 440 represent (for the purposes of this example) three distinct sets of users (e.g., untrustworthy 420 flagged 430 and trustworthy 440). Each group may contain a plurality of users. Although shown as three classification levels, users could be grouped into any number of categories with different levels of reliability as appropriate. Also, users could be categorized into different classifications based on the type of social media site to which they are interacting. A flagged user (e.g., 432 and 436), in this example, is neither trustworthy nor untrustworthy but could be in transition between classifications based on recent activity. User group 440 includes a plurality of users that have been classified as “trustworthy” (e.g., 442 and 446) and are generally considered reliable based on their posting history (if any). Example process flows for categorizing and using categorizations of types 1-3 are outlined below with reference to FIGS. 5A-B. Internet 410 illustrates a greatly simplified view of the actual Internet. Internet 410 includes a plurality of professional forum servers 412, a plurality of social media servers 1-N 414, a plurality of e-commerce servers 1-N 417, and a representation of GTI cloud 310 from FIG. 3. As is known to those of ordinary skill in the art, each of the servers in Internet 410 would have a unique address and identification information which could be used to identify which social environment to associate with a particular host server.

Referring now to FIGS. 5A-B, processes 500 and 550 illustrate example processes flows for an Internet based Reputation Service for a Social Media Identity according disclosed embodiments. Processes 500 and 550 could be performed in the context of an embodiment of GTI cloud 310 (FIG. 3) which in turn could comprise a portion of network architecture 100 (FIG. 1).

Process 500 is illustrated in FIG. 5A. Beginning at block 505, a user posts a “tweet” which is received at a social media server (i.e., a Twitter server in this case). For example, a user named “Spamdude” could post a message such as “Lose weight fast now! I did it and lost 30 pounds! http://sort.url/12.” The post could be analyzed at the posting server or provided to a Reputation Service such as GTI cloud 310 for content and link analysis at block 510. Data referenced by links in the tweet (e.g., http://sort.url/12) can then be analyzed at block 515. The analyzing system can scan the link in the message and find markers for spam and phishing. At block 520, the identity (e.g., real world identity) making the tweet can be determined and possibly verified. In this example, the system could get all information related to “Spamdude” such as prior activity or a score reflective of prior analysis of Spamdude's activity on this site. Next, at block 525 a reputation score maintained for the determined identity can be established or updated based on the existing score and score associated with analysis of the new tweet. In this example, Spamdude's reputation could be downgraded because Spamdude has been associated with spam and phishing. At block 530 the updated score (i.e., overall identity score) and score for the particular tweet can be made available to subscribers of the reputation service. That is, anyone or system requesting information about Spamdude can now be informed that the account/person is associated with spam and phishing. At block 535 subscribers can utilize the available scores to determine if any action (such as filtering) should be taken with respect to the current tweet. Finally, at block 540 users and/or user's machine can receive an indication of item score and identity score and (if the tweet was not previously filtered) can utilize/update configuration information so that the tweet is handled based on the desires of the user intended to receive the tweet. The indication could comprise individual pieces of information (e.g., individually provide the post score and the reputation as different pieces of information) or a composite single indication for the post taking into account the existing reputation. Also, applications such as those that relay messages or display messages in websites can perform a lookup and automatically block based on reputation scores. Generally, having the above indications can allow both visual and automatic filtering of information based on reputational score, including, but not limited to: hiding, deleting, promoting, highlighting, or generally changing the visual significance of information from social media sites. Variations and combinations of these and other potential options for a user are also possible.

Process 550 is illustrated in FIG. 5B. Beginning at block 555, posts (i.e., input to social media environment as appropriate) can be obtained from multiple sources such as different social media environments. Continuing the above example, Spamdude's accounts on both Twitter and Facebook could be considered. At block 560, the multiple sources and posts can be normalized to tie them back to a social media identity. For example, Spamdude's accounts can be tied across sites if they both refer to the same email (e.g., spam_dude@gmail.com) or if they both refer to a “John Smith” from Shiner, Texas with a birthdate of Dec. 28, 1973. An aggregate score across multiple input sources (possibly with a weighting factor applied to each source) can be determined (block 565). Next, at block 570 a score could be determined for a new post, the score taking into account the identity's previous aggregate score. At block 575, the aggregate score can be updated based on analysis of new information associated with a new post. The item score and aggregate score for the posting identity can be made available to subscribers at block 580. In this example, when Spamdude posts a message on Facebook such as “I got smarter, stronger and sexier with this simple rule: http://short.url/13,” the reputation service could perform a similar analysis to block 515 above and alter the reputation score for Spamdude as to both social media sites as appropriate. At block 585, subscribers can take action based on the provided information as required prior to making the new item available to end users. Finally, at block 590 users and/or user's devices can receive an indication of the new item's score and aggregate score for use in a manner similar to block 540 (FIG. 5A) described above.

As should be apparent from the above explanation, embodiments disclosed herein allow the user, the reputation services server, web sites and end users to work together to create and determine (in an on-going manner) a reputation of an identity on the Internet. Also, in the embodiments specifically disclosed herein, the reputation has been formed from the context of a post; however other types of Internet interaction by an identity are contemplated and could benefit from concepts of this disclosure. It may also be worth noting that both the score and reputation of an identity may be applied to more than just web based environments and could be used in real world transactions to bolster or deflate a person's reputation. For example, credit rating or loan approval amounts could be lowered or raised in the real world.

In the foregoing description, for purposes of explanation, numerous specific details are set forth in order to provide a thorough understanding of the disclosed embodiments. It will be apparent, however, to one skilled in the art that the disclosed embodiments may be practiced without these specific details. In other instances, structure and devices are shown in block diagram form in order to avoid obscuring the disclosed embodiments. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one disclosed embodiment, and multiple references to “one embodiment” or “an embodiment” should not be understood as necessarily all referring to the same embodiment.

It is also to be understood that the above description is intended to be illustrative, and not restrictive. For example, above-described embodiments may be used in combination with each other and illustrative process steps may be performed in an order different than shown. Many other embodiments will be apparent to those of skill in the art upon reviewing the above description. The scope of the invention therefore should be determined with reference to the appended claims, along with the full scope of equivalents to which such claims are entitled. In the appended claims, terms “including” and “in which” are used as plain-English equivalents of the respective terms “comprising” and “wherein.”

What is claimed is:

1. A non-transitory computer readable medium comprising computer executable instructions stored thereon to cause a processor to:
receive content from an electronic message;
analyze the content to determine a content score for the electronic message;
determine a first identity associated with the electronic message;
obtain a reputation score for the determined identity; and
provide an individual message score based on a combination of the content score and the reputation score.

2. The non-transitory computer readable medium of claim 1 further comprising instructions to cause the processor to:
analyze data referenced by one or more links in the content of the electronic message wherein information pertaining to results of the data analysis contributes to determining a content score for the electronic message.

3. The non-transitory computer readable medium of claim 1 wherein the individual message score comprises two scores, a first score for the content score and a second score for the reputation score.

4. The non-transitory computer readable medium of claim 1 further comprising instructions to cause the processor to:
update the reputation score for the determined identity based on the determined content score; and
provide the reputation score in response to requests pertaining to the determined identity.

5. A method of determining a quality score to associate with a post to a social media environment, the method comprising:
analyzing, on a processor, the content of a social media post to a first social media environment from a first user account;
obtaining attributes of the first user account;
analyzing, on the processor, the obtained attributes;
determining a quality score for the social media post based on the analysis of the content and the attributes of the first user account; and
associating the quality score with the social media post.

6. The method of claim 5, wherein the act of analyzing the obtained attributes comprises determining a factor to apply to the quality score based on account age.

7. The method of claim 5, wherein the act of analyzing the obtained attributes comprises determining a factor to apply to the quality score based on historical activity associated with the first user account in the first social media environment.

8. The method of claim 5, further comprising
determining an identity to associate with the first user account;
identifying at least one post to a second social media environment associated with the determined identity; and
determining a factor to apply to the quality score based on historical activity associated with the identity in the second social media environment.

9. The method of claim 5, wherein analyzing the obtained attributes comprises determining a factor to apply to the quality score based on a previously determined reputation score associated with the first user account.

10. The method of claim 5, wherein analyzing the obtained attributes comprises determining a factor to apply to the quality score based on reputation scores previously determined for a plurality of other user accounts that are designated as associated with the first user account.

11. The method of claim 10, wherein the plurality of other user accounts comprise user accounts designated as followers of the first user account.

12. The method of claim 5, further comprising
determining an identity to associate with the first user account;
obtaining a reputation score for the determined identity; and
updating the reputation score for the determined identity based on the quality score determined for the social media post.

13. The method of claim 12 wherein the obtained reputation score comprises an undefined reputation score and updating the reputation score comprises initially setting a reputation score for the determined identity.

14. The method of claim 5 wherein the first social media environment is selected from the group consisting of: a professional forum, an e-commerce forum, an Internet dating forum, and a social forum.

15. The method of claim 5 wherein the content of a social media post is selected from the group consisting of: a tweet message, a blog post, a re-tweet message, a comment entry pertaining to another post, and a forum discussion entry.

16. A method of providing a reputation service associated with one or more social media environments, the method comprising:
obtaining a plurality of posts to a social media environment;
correlating the plurality of posts to a single identity;
analyzing the correlated posts to determine a content score for the single identity;
analyzing attributes of one or more accounts associated with the single identity to determine an identity score;
determining a reputation category for the single identity; and
associating the determined reputation category as a social media reputation indicator for the single identity.

17. The method of claim 16 wherein obtaining a plurality of posts comprises obtaining at least one post from more than one social media environment.

18. The method of claim 17 further comprising:
applying a weighting factor to information obtained from each of the more than one social media environments prior to determining a reputation category for the single identity.

19. The method of claim 16 further comprising:
providing an indication to filter posts made by the single identity based on the determined reputation category.

20. A non-transitory computer readable medium comprising computer executable instructions stored thereon to cause a processor to:
obtain a plurality of posts to a social media environment;
correlate the plurality of posts to a single identity;
analyze the correlated posts to determine a content score for the single identity;
analyze attributes of one or more accounts associated with the single identity to determine an identity score;
determine a reputation category for the single identity; and
associate the determined reputation category as a social media reputation indicator for the single identity; and
provide the social media reputation indicator in response to a request associated with a social media environment post.
